(19) United States
(12) Patent Application Publication
(10) Pub. No.: US 2011/0189392 A1
(43) Pub. Date: Aug. 4, 2011

(54) APPARATUS AND METHOD FOR PRODUCING REINFORCED COMPOSITE POLYURETHANE MATERIALS

(75) Inventors: Detlef Mies, Elsdorf (DE); Andreas Frahm, Leverkusen (DE); Hans-Guido Wirtz, Leverkusen (DE)

(73) Assignee: BAYER MATERIAL SCEINCE AG, LEVERKUSEN (DE)

(21) Appl. No.: 12/739,251

(22) PCT Filed: Oct. 16, 2008
(86) PCT No.: PCT/EP08/08761

§ 371 Date: Apr. 22, 2010

(30) Foreign Application Priority Data
Dec. 15, 2005 (DE) 10-2005-059-890.0

(51) Int. Cl. B05D 1/12; B05B 1/00; B05C 19/04; B05C 11/10; B05C 11/00; B05D 1/02

(52) U.S. Cl. 427/196; 118/612; 901/43

(57) ABSTRACT

The invention relates to a device and a process for the preparation of polyurethane composite materials reinforced by fibers or solid particles, comprising at least one PUR spray-mixing head with a defined spraying direction and at least one application means for the directional application of fibers and/or solid particles, characterized in that the exiting direction of the fibers and/or solid particles can be changed in space relative to the spraying direction of the PUR spray-mixing head.

The invention relates to a device and a process for preparing reinforced polyurethane composite materials.

Spraying methods for the preparation of polyurethane composite materials reinforced by fibers or solid particles have long been known. The preparation of such materials is usually effected by conducting the fibers or solid particles used for reinforcement through a funnel-shaped application means, which is fixedly attached to the PUR spray-mixing head, laterally into the spray jet of the PUR reactive mixture, preferably aided by pressurized air.

In the case of fiber-reinforced materials, so-called rovings are mostly employed as the starting material; these are bundles of continuous untwisted drawn fibers, which at first pass through a cutting unit, which is optionally also attached to the PUR spray-mixing head, and then the cut fibers are transferred to the chute.

In spraying methods of this kind, a distribution of the fiber/particle-PUR reaction mixture that is as uniform as possible on the mold surface or the substrate support is sought, mostly through several layers. In applications with a high demand for reproducibility, the spray-mixing heads as well as the chute are therefore guided by robots.

The device and the process wet the solid particles with polyurethane-forming reactive mixture substantially from all sides, which results in a significant increase of viscosity and thixotropication of the polyurethane-forming reaction mixture. This in turn has the effect that the polyurethane-forming reactive mixture can be applied to slants or even vertical surfaces without flow.

What is also important is the effect that the mixture permeates a fibrous web more slowly due to the increase of viscosity and thixotropication, so that the solids content can be used to adjust how much polyurethane-forming reactive mixture will remain at the surface and how much will penetrate into the interior of the composite component. By this additional degree of freedom, an optimum compromise between sufficient adhesive bonding of the composite, low weight and good surface finish of the construction element can be achieved.

The filler also has a positive influence on the microstructure at the surface of the construction element. The flow properties of the pure polyurethane-forming reactive mixture onto the substrate, which may contain a fibrous web, for example, is comparable to the flow of a liquid through a packed bed. Gravity or the pressure difference applied by the closing of the mold causes the liquid to flow through the packed bed (the fibrous web).

At the surface, the liquid does not form a smooth surface towards the atmosphere due to the fibrous structure; instead, the polyurethane-forming reactive mixture forms an inhomogeneous surface due to the interplay of interface or surface tensions towards the fibrous material and the air and due to the flowing properties. This results in air becoming entrapped between the fibers.

The fine-grained filler wetted with the polyurethane-forming reactive mixture can fill these spaces at the surface better and thereby significantly improve the microstructure at the surface. This is achieved, on the one hand, by the fact that the flow resistance is increased due to the higher viscosity and, on the other hand, because the interface between the reactive mixture, air and fibers is broken up by the solid particles. Thus, the tendency to form a curved surface between the fibers at the surface due to the interfacial forces is significantly lesser.

A particular effect occurring in this process is the fact that although the PUR reactive mixture penetrates into the at least one fibrous web and wets all the fibers during the reaction of the thixotropicated PUR reactive mixture during the molding process in a press mold to cause the fibers to become bonded with one another, the solid particles wetted with the PUR reactive mixture are in part filtered off by said at least one fibrous web and become stuck to the surface of said at least one fibrous web, filling all the voids between the individual fibers. In this way, high-strength light-building construction elements with a flawless homogeneous surface and an unobjectionable formation of the desired contours are produced without having to effect additional reworking or laminating steps.

WO 2007/073825 also describes a spray head for spraying polyurethane-forming reactive mixture charged with solid particles, comprising:

a) at least one spray-mixing head for the polyurethane-forming reactive mixture containing a spray nozzle for the polyurethane-forming reactive mixture; and

b) at least one first conduit section for pneumatically conveying the solid particles comprising an inlet opening for a gas stream and an intake fitting for the solid particles arranged substantially concentrically in the first conduit section, having a center of gravity axis of the first conduit section extending in the particles' flow direction and a spray jet axis extending in the spray nozzle's direction of spray which form an angle α in the range of from 10° to 120°, and

c) at least one second conduit section for pneumatically conveying the solid particles, into which the first conduit section opens, the first conduit section's center of gravity axis extending in the flow direction and the second conduit's outlet opening center of gravity axis extending in the flow direction forming an angle β in the range from 60° to 170°, wherein the outlet opening of the second conduit section is substantially arranged in immediate proximity to the spray nozzle for the polyurethane-forming reactive mixture and is substantially oriented towards the spray nozzle's emerging jet spray of polyurethane-forming reactive mixture.

Thereby, it is achieved that the flow of solid particles emerging at the outlet opening of the second conduit section opens into the spray jet exiting the spray nozzle for the polyurethane-forming reactive mixture. Usual PUR mixing heads working according to the high or low pressure mixing method can be used as said spray-mixing heads. Round or flat jet spray nozzles working by means of pressure or air atomization can be adapted to such mixing heads.

One serious drawback of a fixed lateral attachment of the application means to the PUR spray-mixing head as used in the prior art is the geometric dependence of the fiber/particle input into the spray jet on the robot's moving direction, which in turn causes the wetting of the fibers/particles to vary as a function of the path taken by the spray-mixing head (FIG. 1). Depending on the side on which the application means is attached or the moving direction of the PUR spray-mixing head, the fibers/particles are either captured by the PUR spray jet and sprayed over by the subsequent reaction mixture, or conveyed into the leading spray jet.

Fibers/particles sprayed over by the subsequent reaction mixture (FIG. 1, moving direction to the right) exhibit a significantly more intensive wetting on the (upper) side facing towards the PUR spray-mixing head. In contrast, the side of the rovings facing towards the mold or substrate support can have a substantially weaker and thus usually insufficient wetting, which very often leads to ultimate imprints or cavities on decorative layers.

Part of the fibers/particles that are to be conveyed into the leading spray jet (FIG. 1, moving direction to the left) are captured by the air flow of the PUR spray jet and deflected. In such a case, the fibers/particles are deposited outside the spray jet proper, which results in an insufficient fixation of the fibers/particles-PUR reaction mixture at the contact area with the regions previously sprayed with reaction mixture.

Thus, the degree of wetting of the fibers/particles is directly related to the input conditions and clearly has an influence on:

1. the mechanical properties

2. the surface finish

3. formation of cavities in the polyurethane layer

4. imprint from fibers on interfaces with decorative layers

5. the input of the maximum possible amount of glass.

Apart from the dependence of the fiber/particle input on the site of attachment of the application means or the moving direction of the PUR spray-mixing head as outlined above, there is another problem in devices having an application means fixedly attached to a PUR spray-mixing head in that the deposition of fibers/particles is more difficult in radii (or cavities) and marginal regions of three-dimensional shapes.

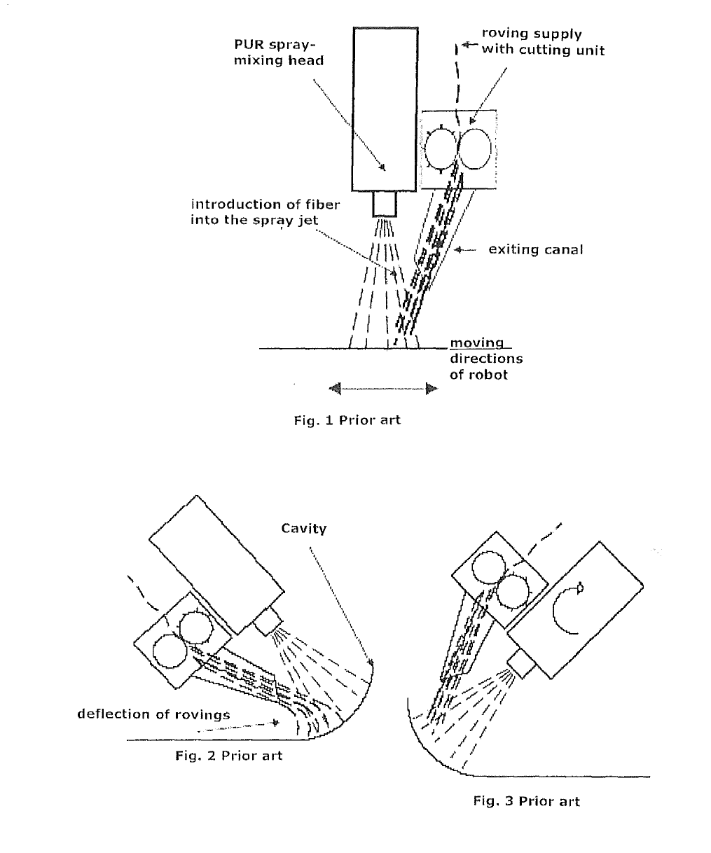

To be able to realize a fiber/particle deposition to the marginal regions, the spraying angle is adapted to the course of the cavity through the robot by rotating the PUR spray-mixing head. Nevertheless, the cavity's being sprayed over must often be accepted, with an inhomogeneous fiber distribution. In some cases, a complete wetting with the fiber/reaction mixture is almost impossible (FIGS. 2 and 3).

When the fibers/particles are deposited into the leading PUR reaction mixture (following the spray jet), the fibers are captured by the spray jet and pressed into the bottom of the cavities (FIG. 2) (this is also in part due to the fact that fibers/particles follow gravity and “fall out of the spray jet” in this moving direction).

However, for the same attachment situation of the application means, the input behavior on the opposite mold will change (FIG. 3). The rotation of the PUR spray-mixing head and the now more favorable entering of the fibers/particles enables deposition up to the high marginal region of the cavity. The entering fibers/particles are fixed on the cavity over the entire jet range of the PUR reaction mixture without being pressed onto the bottom regions of the mold.

Therefore, it is an object of the present invention to provide a device that avoids the above described problems of the prior art arising from the fixed attachment of the application means for the fibers/solid particles to the PUR spray-mixing head. In particular, it is an object of the present invention to design a device to enable PUR molded parts reinforced by fibers/solid particles (optionally built from several layers) to be prepared with a reproducible deposition and wetting of the fibers/solid particles independent of the moving direction of the PUR spray-mixing head even for three-dimensional shapes.

In a first embodiment, the object of the invention is achieved by a device for the preparation of polyurethane composite materials reinforced by fibers and/or solid particles, comprising at least one PUR spray-mixing head with a defined spraying direction and at least one application means for the directional application of fibers and/or solid particles, characterized in that the exiting direction of the fibers and/or solid particles can be changed in space relative to the spraying direction of the PUR spray-mixing head.

An application means within the meaning of the present invention means, in particular, a hollow body serving as the outlet canal for guiding the fibers, i.e., the cut rovings, and/or the solid particles. This may be, for example, a (funnel-shaped) chute, but also, for example, a tube or flexible tube having at least one defined outlet opening. Preferably using pressurized air, this application means serves for the guidance of the fibers/solid particles to be introduced into the PUR reactive material and provides them with a defined exiting direction, either by directing the application means as such or by components present in the application means that deflect the jet of fibers/solid particles.

The changing of the exiting direction of the fibers and/or solid particles in space relative to the spraying direction of the PUR spray-mixing head is to be understood, on the one hand, in relation to the angle formed between these directional vectors (corresponding to a change of direction of one directional vector within the plane spanned by itself and the other vector), for example, caused by a change of the orientation of the application means relative to the spraying direction of the PUR spray-mixing head.

On the other hand, however, it also includes those changes wherein the orientation in space of the plane spanned by two vectors is changed.

Not according to the invention in this context are those changes of direction that result from a change of the exiting speed of the fibers/solid particles, in other words, a corresponding change of the mutual orientation of the vectors must be possible for a constant exiting velocity.

Preferred are those changes of the exiting direction of the fibers/solid particles relative to the spraying direction of the PUR spray-mixing head in which a movement of the vector of the exiting direction of the fibers/solid particles around the vector of the spraying direction of the PUR spray-mixing head is possible, wherein the application means moves on a circular path of 360°, but at least 180°, relative to the spraying direction of the PUR reactive mixture. This movement can be such that the tip of one vector travels on an elliptic or preferably circular path around the other vector.

Further, it is possible that the exiting direction of the fibers/solid particles can be changed relative to the spraying direction of the PUR spray-mixing head independently of any change of the latter. This is to be understood to mean that when the position of the PUR spray-mixing head in space is constant (irrespective of, for example, a possible rotational movement of the PUR spray-mixing head around itself), a change of the exiting direction of the fibers/solid particles is to be possible (based on the vectorial interpretation described above).

Also, it is possible that the exiting direction of the fibers/solid particles can be changed independently of any movement of the PUR spray-mixing head. This can be achieved if a change of the exiting direction of the fibers/solid particles relative to the spraying direction of the PUR spray-mixing head is to be possible while the PUR spray-mixing head is stationary in space, i.e., does not perform any movement (which does not exclude, however, that the PUR spray-mixing head as such may be mobile in principle, i.e., can be rotated around its axis, for example).

Preferably, the application means, especially the exiting canal of the cutting unit or the blowing means, is directly or indirectly connected with the PUR spray-mixing head that is controlled, in particular, by a robot. A direct connection is supposed to mean one in which there is a physical contact between the application means and the PUR spray-mixing head. This can be achieved, for example, by attaching the application means to the PUR spray-mixing head or by indirectly connecting it thereto through connecting struts, spacers or a cutting unit (compare, for example, FIG. 1). In an indirect connection, although there is no direct attachment to the PUR spray-mixing head, the component is nevertheless connected with the PUR spray-mixing head within the meaning of the invention (for example, through a robot arm). Therefore, what is characteristic for both direct and indirect attachment is the fact that the application organ on the one hand and the PUR spray-mixing head on the other cannot be guided independently of one another.

In order to achieve as uniform as possible a distribution of the reaction mixture consisting of the PUR reactive mixture on the one hand and the fibers/solid particles on the other and to ensure a high reproducibility, it is preferred to attach the above device to a robot/robot arm. The usual controlling is then effected accordingly by a usual electronic data processing unit.

In a second embodiment, the object of the invention is achieved by using the device as described above for the preparation of polyurethane composite materials reinforced by fibers or solid particles.

In a third embodiment, the object of the invention is achieved by a process for the preparation of polyurethane composite materials reinforced by fibers or solid particles in which the device described above is employed and the application means for the fibers/solid particles is coupled to the moving direction of the PUR spray-mixing head. The adaptation of the exiting direction of the fibers/solid particles to the moving direction of the PUR spray-mixing head is preferably effected in such a way that the fibers/solid particles are introduced into the “lagging” spray jet of the PUR spray-mixing head (FIG. 1, moving direction to the right). This is the only way to enable the reproducible production of PUR molded parts reinforced by fibers/particles with uniform wetting of the fibers/particles even for highly demanding three-dimensional shapes. In particular, the process according to the invention is characterized in that the flow of the fibers/solid particles is changed relative to the spray jet of the PUR reactive mixture by continuous control.

Preferably, the amount of solid particles applied is adjusted in such a way that only an amount of solid particles is applied to the substrate as required to compensate for uneven surfaces or fractured edges or retracted stress sites. The optimum amount of PUR reactive mixture and solid particles to be applied can be easily established by the skilled person by simple experiments in which different amounts of PUR reactive mixture and solid particles are applied to the substrate or composite element.

As the solid particles, especially those having a grainy or powdery structure with grain sizes in a range of from preferably 5 μm to 500 μm may be used. In particular, mixtures of different grain sizes are important since this enables optimum packing densities in order to compensate for irregular unevenness at the surface of the substrates. It has been found that powders made from recycled and finely ground PUR foams, especially of rigid foams, are suitable as particle mixtures. The comminuting of the cellular structures generates a mixed particle size of preferably 10-30, for example, about 20, % by weight of above 300 μm, 30-50, for example, about 40, % by weight of above 100 μm and below 300 μm, and 30-50, for example, about 40, % by weight of below 100 μm (values established by sifting).

Fibers having number average fiber lengths of preferably 5 μm to 500 μm and a diameter-to-length ratio of preferably 1.0 to 0.01 (rovings) are also suitable according to the invention. Preferably, the microfibers are made of the same material as said at least one substrate, especially fibrous web, to be coated. Homogeneous and at the same time fibrous surface structures are obtained thereby. Above all, it is to be taken care that fractured edges in composite elements including spacer elements (e.g., honeycomb structure) or retracted stress sites are leveled out in order to achieve a flawless formation of the contours and wall thicknesses.

Solid particles with a platelet shape and number average platelet diameters (e.g., established by microscopic analysis) of preferably 5 μm to 500 μm and thickness-to-diameter ratios of preferably 1.0 to 0.01 are also suitable as solid particles in the process. In this way, special surface structures can be produced. For example, platelets made of glass or mineral are suitable for increasing the indentation resistance of the surface.

Preferably, glass, mineral, metal, plastic fibers or natural products, such as hemp or jute, may be employed as the fibers. As a rule, those fibers/solid particles that are particularly light-weight will be mainly employed. Therefore, plastic materials are preferred. In order to achieve special surface effects, metal powders with which an optical metallic effect can be achieved are particularly suitable, for example.

Mixtures of different solid particles in terms of different materials and/or structures and/or particle size distributions may also be employed as solid particles. However, mixtures of the same material and the same structure with different volume average grain sizes may also be employed.

Preferably, the fibers/solid particles are introduced into the flow of PUR reactive mixture before spraying and sprayed onto the substrate along with the mixture. In this way, the solid particles are optimally wetted from all sides. In addition, the desired thixotropication of the PUR reactive mixture exhibits a direct effect, i.e., without any delay.

However, especially for simple applications, it is also possible to apply the fibers/solid particles to the PUR reactive mixture of the fibrous web only after the spraying or wetting of the substrate with the PUR reactive mixture. However, this later application of the solid particles is preferably effected immediately, i.e., without substantial delay, after the application of the PUR reactive mixture in order to ensure the required thixotropication of the PUR reactive mixture within the time tolerance range.

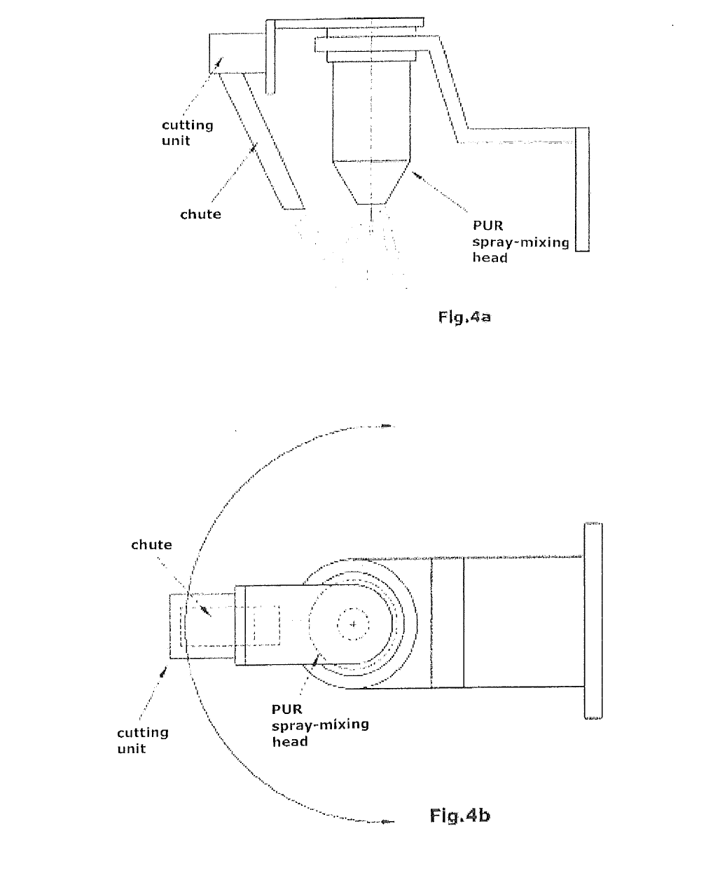

The present invention shall be explained and illustrated in an exemplary way by means of the embodiments shown in FIGS. 4-7, wherein:

FIG. 1 shows a device for the preparation of reinforced polyurethane composite materials of the prior art comprising an application means (in this case a funnel-shaped chute) rigidly connected with the PUR spray-mixing head through a cutting unit.

FIGS. 2, 3 show problems resulting when cavities are sprayed out using a device of the prior art.

FIG. 4a, b show schematic images of a device according to the invention in lateral view and top plan view, comprising a PUR spray-mixing head and a combination rotatably attached thereto and consisting of a cutting unit and a funnel-shaped chute. This construction ideally enables a freely selectably position of the cutting unit/chute combination over the pivoting range of the device, wherein preferably the rotating drive is designed as the 7th axis of the robot and thus the input of fibers/solid particles into the PUR spray jet can be matched to the robot's sequences of movement.

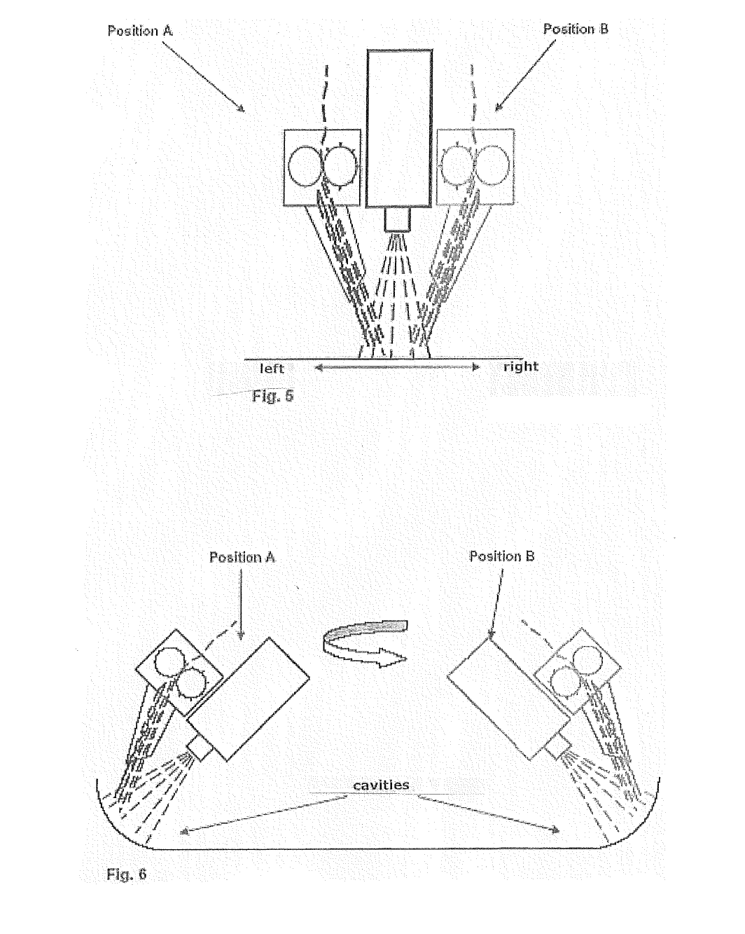

FIGS. 5 and 6 show the principle of a device according to the invention.

If, as shown in FIG. 5, the PUR spray-mixing head moves to the left, for example, then the combination of cutting unit and chute is also on the left side (position A) to thus enable introduction of the fibers/particles into the “lagging” PUR spray jet, which results in a better wetting of the fibers/solid particles as discussed above (compare discussion relating to FIG. 1). Now, if the moving direction of the PUR spray-mixing head is changed to the right (rotation by 180°), the cutting unit/chute combination also rotates to the right (under computer control) in order that the introducing direction of the fibers/particles into the PUR spray jet can be maintained unchanged. Independently of the change of the moving direction of the spray head as effected by the robot, the introduction of fibers/particles can thus be effected under constant conditions due to a corresponding rotation of the cutting unit/chute combination.

The advantages of this device according to the invention are particularly clearly manifested when cavities are sprayed out, as shown in FIG. 6. The combination of cutting unit and chute is always above the PUR spray jet, so that the introduction of fibers/solid particles can be effected to the outer periphery of the cavities. In addition, the wedge-shaped introduction of the fibers/solid particles between the cavity and spray jet allows for fiber deposition and fixation also in extremely steep mold and radius ranges.

Thus, in summary, an absolutely symmetrical fiber distribution of the two molds is enabled by the rotation of the cutting unit/chute combination.

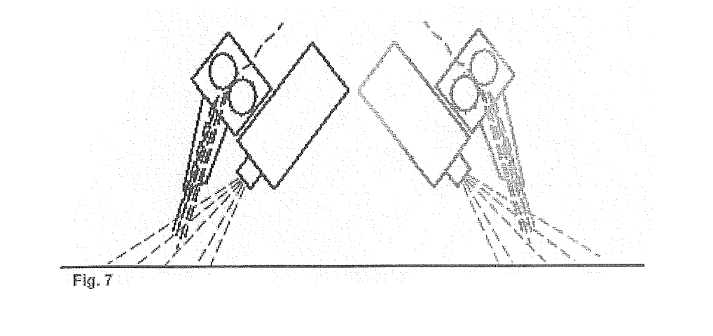

Much like FIG. 6, FIG. 7 shows a special type of mixing head guidance on flat planes in which a larger introduction area (projected ellipsis) for the entering fibers is produced by the inclined position of the PUR spray-mixing head, whereby significantly higher amounts of fibers and solid particles can also be processed as compared to usual processes (vertical to the surface).

1.-10. (canceled)

11. A device for the preparation of polyurethane composite materials reinforced by fibers and/or solid particles, comprising at least one PUR spray-mixing head with a defined spraying direction and at least one application means for the directional application of fibers and/or solid particles, wherein the exiting direction of the fibers and/or solid particles can be changed in space relative to the spraying direction of the PUR spray-mixing head independently of such spraying direction.

12. The device according to claim 11, wherein the exiting direction of the fibers and/or solid particles can be changed in space relative to the spraying direction of the PUR spray-mixing head while the exiting velocity of the fibers/solid particles remains constant.

13. The device according to claim 11, wherein the change of the exiting direction of the fibers/particles travels on a circular path around the spraying direction of the PUR spray-mixing head.

14. The device according to claim 11, wherein the exiting direction of the fibers/solid particles can be changed relative to the spraying direction of the PUR spray-mixing head independently of any change of the latter.

15. The device according to claim 11, wherein the exiting direction of the fibers/solid particles can be changed independently of any movement of the PUR spray-mixing head.

16. The device according to claim 11, wherein the application means is directly or indirectly connected with the PUR spray-mixing head.

17. The device according to claim 11, wherein the device is incorporated as part of a robot or robot arm.

18. A process for the preparation of polyurethane composite materials reinforced by fibers and/or particles in which a PUR reactive mixture is sprayed from a spray head on the one hand, and fibers/solid particles are sprayed from an application means on the other hand, onto a substrate, wherein the flow of the fibers/solid particles is changed relative to the spray jet of the PUR reactive mixture by continuous control.

19. The process according to claim 18, wherein an angle, w, between the exiting direction of the fibers/particles and the surface to be sprayed is adjusted within a range of 0°<w<90°

20. The process according to claim 18, wherein an angle, w, between the exiting direction of the fibers/particles and the surface to be sprayed is adjusted within a range of 20°≦w≦70°.
